(19) United States
(12) Patent Application Publication
(10) Pub. No.: US 2008/0070521 A1
(43) Pub. Date: Mar. 20, 2008

(54) SYSTEM AND METHOD FOR CONTROLLING GAIN OF RELATED SIGNALS

(75) Inventors: Brian West, Tampa, FL (US); Juan C. Fernandez, Riverview, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/530,922

(22) Filed: Sep. 12, 2006

(51) Int. Cl. H04B 17/02

(52) U.S. Cl. 455/136

(57) ABSTRACT

An electronic system comprises two or more receivers, each receiver having a defined range for input signals; and an automatic gain control circuit configured to adjust the gain of two or more signals and pass the two or more adjusted signals to the two or more receivers, wherein the automatic gain control circuit adjusts the gain of each of the two or more signals based on an analysis of all of the two or more signals.

### GOVERNMENT INTEREST STATEMENT

The U.S. Government may have certain rights in the present invention as provided for by the terms of a restricted government contract.

### BACKGROUND

Many receivers have a finite input dynamic range. The input range of a receiver is the difference between a maximum input level accepted by a receiver and a minimum voltage level needed for adequate resolution and/or accuracy. If the input signal exceeds the maximum input level of a receiver, the signal may be clipped or distorted by the receiver. Similarly, if the input signal level is below the minimum voltage level, the receiver may not accurately measure and/or detect the signal.

When an input signal is able to vary over a greater range than the input range of a receiver, automatic gain control may be necessary to condition the signal such that it is within the dynamic range of the receiver. When more than one signal is being received, the gain of each signal may need to be adjusted to keep each signal within the dynamic range of the receiver. Performing automatic gain control on multiple signals becomes more difficult when the strength of each signal relative to the strength of the other signals needs to be maintained.

### SUMMARY

The above-mentioned problems and other problems are resolved by the present invention and will be understood by reading and studying the following specification.

In one embodiment, an electronic system is provided. The electronic system comprises two or more receivers, each receiver having a defined range for input signals; and an automatic gain control circuit configured to adjust the gain of two or more signals and pass the two or more adjusted signals to the two or more receivers, wherein the automatic gain control circuit adjusts the gain of each of the two or more signals based on an analysis of all of the two or more signals.

### DRAWINGS

The present invention can be more easily understood and further advantages and uses thereof more readily apparent, when considered in view of the description of the following figures in which:

FIG. 1 is a high level block diagram of a system according to one embodiment of the present invention.

FIG. 2 is a block diagram of an automatic gain control circuit according to one embodiment of the present invention.

FIG. 3 is a schematic diagram of a peak detector and summation circuit according to one embodiment of the present invention.

FIG. 4 is a schematic diagram of an attenuator according to one embodiment of the present invention.

FIG. 5 is a flow chart showing a method of adjusting the gain of two or more signals according to one embodiment of the present invention.

FIG. 6 is a flow chart showing a method of analyzing a characteristic of two or more related signals.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should be understood that the exemplary method illustrated may include additional or fewer steps or may be performed in the context of a larger processing scheme. Furthermore, the method presented in the drawing figures or the specification is not to be construed as limiting the order in which the individual steps may be performed. The following detailed description is, therefore, not to be taken in a limiting sense.

Embodiments of the present invention adjust the gain of each of a plurality of signals based on an analysis of all of the signals. By basing the gain adjustment on analysis of all the signals, the relative signal strength of the signals can be more easily maintained than by individually adjusting the gain of each signal. In addition, the sum of the signals' strengths as well as individual signal strengths can be maintained within the maximum input range of a receiver without affecting the relative signal strengths of the signals.

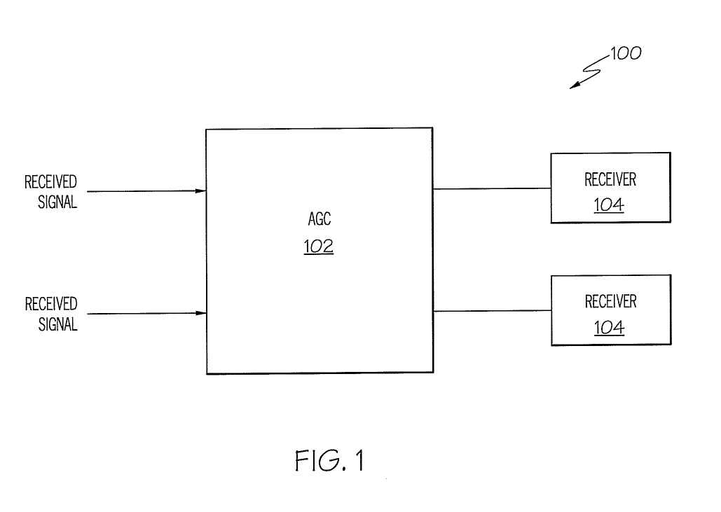

FIG. 1 is a high level block diagram of a system 100 according to one embodiment of the present invention. System 100 is adapted to adjust the gain of each of two received signals based on an analysis of both of the signals. Notably, two signals are received in this example. However, embodiments of the present invention are not to be so limited, and any appropriate number of signals can be used in other embodiments.

System 100 includes automatic gain control (AGC) circuit 102 and receivers 104. In some embodiments, receivers 104 have a limited input range. For example, in one embodiment, receivers 104 have a input range of ±20% nominal voltage of a received signal. AGC circuit 102 is configured to analyze the two received signals and adjust the gain of each of the two signals based on the analysis of both signals. AGC circuit 102 then passes the adjusted signals to receivers 104. In particular, in this example, AGC circuit sums the signal strength of the two received signals and adjusts the gain of each of the signals based on a comparison of the summed signal strength with a reference value. However, it is to be understood that other analysis is performed in other embodiments. For example, in another embodiment, the signal strength of each signal is measured and both signals are attenuated substantially equally if either of the signals exceeds a reference value.

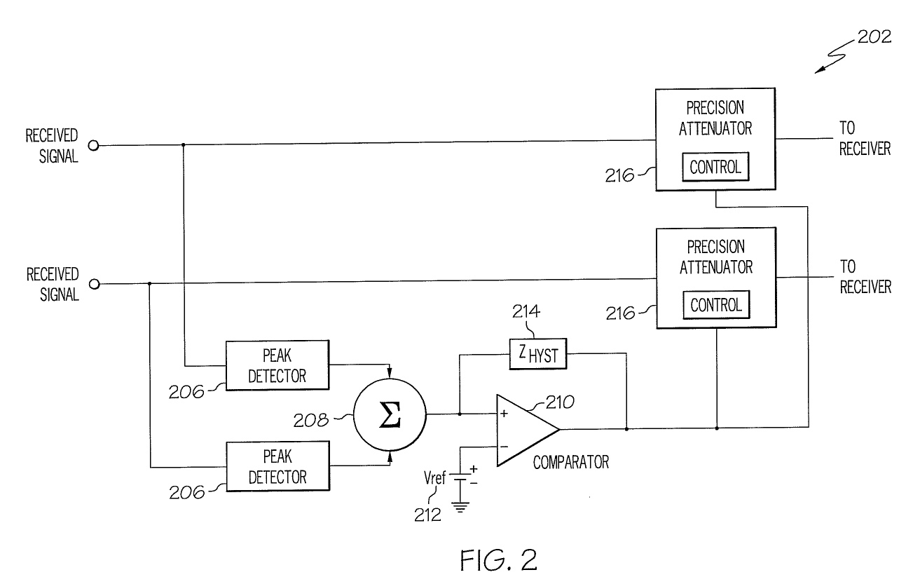

FIG. 2 is a high level block diagram of an automatic gain control circuit 202 according to one embodiment of the present invention. AGC circuit 202 is one example of an AGC circuit 102 in FIG. 1. In this example, AGC circuit 202 includes peak detectors 206, summation circuit 208, comparator 210 and attenuators 216.

Peak detectors 206 determine the peak voltage on each of two received signals and convert the respective peak voltages into direct current (DC) voltages. In this example, each of the two received signals is a sinusoidal signal. Peak detectors 206 are adapted to detect the peak amplitude of each signal per cycle and output the detected amplitudes as DC voltages. Notably, although only two signals are received in this example, it is to be understood that any appropriate number of signals can be received in other embodiments. The DC peak voltages for the two signals are then summed together in summation circuit 208. In this example, it is desirable for the sum of the two signals' strengths to remain within a maximum value. Also in this example, any adjustment to the signal strength of the two signals should maintain the relative strength of the signals with respect to each other. That is, the percentage of the signal strength sum contributed by each signal should remain substantially the same after adjustments to each signal's strength.

To determine if the sum is greater than the maximum value, the sum of the DC peak voltages is compared to a reference voltage 212 in comparator 210. In addition, a hysteresis feedback component 214 is included to provide feedback to comparator 210. Feedback component 214 can be a resistor, capacitor, inductor, etc. which provides a feedback impedance. Feedback component 214 is configured to provide feedback such that small changes in the sum of the DC peak voltages do not cause the output of the comparator to switch back and forth between values. If the output of comparator 210 were to switch back and forth, the adjustment of the signal strength will also be switched back and forth. For example, if the sum of the DC peak voltages is about equal to the reference voltage 212, small changes which cause the sum to exceed the reference voltage 212 and then drop below the reference voltage 212 will cause the output of comparator 210 to switch from one corresponding level to the other. Feedback component 214 is configured to prevent such repeated switching from one level to another unless a substantial change to the sum of the DC peak voltages occurs.

Attenuators 216 each receive the output from comparator 210. Based on the output, each of attenuators 216 attenuates one of the two received signals. In this embodiment, attenuators 216 attenuate the received signals substantially the same to maintain the relative signal strength of each signal with respect to the other. However, in other embodiments, each of attenuators 216 can attenuate the signals differently. For example, in one embodiment, the sum of the two signals needs to be maintained within a maximum amount, but the relative strength of the signals does not need to be maintained. If the sum of the signals' strengths or the signal strength of either of the individual signals exceeds a given value, then both signals are attenuated. However, in such an embodiment, the two signals do not have to be attenuated equally since the relative signal strengths do not have to be maintained.

In addition, in this embodiment, attenuators 216 attenuate the signals in discrete attenuation levels. In particular, attenuators 216, in this embodiment, attenuate in two levels of attenuation. One level is used when the sum exceeds the reference voltage 212 and the other is used the sum does not exceed the reference voltage 212. For example, in one embodiment, each attenuator 216 attenuates one of the two signals by 10% when the sum exceeds the reference voltage 212 and does not attenuate the received signals when the sum does not exceed the reference voltage 212.

However, it is to be understood that in other embodiments, other numbers of discrete attenuation levels are used. One benefit of using discrete attenuation levels is that it is easier to achieve precise attenuation than with a linear function. The ability to achieve precise attenuation is important in order to configure attenuators 216 to attenuate substantially the same amount. However, it is to be understood that in other embodiments attenuators 216 are configured to attenuate the received signals with a continuous linear function. For example, in one such embodiment using a continuous linear function in attenuators 216, comparator 210 is replaced with an operation amplifier (op amp) which is configured to output varying voltages levels based on the relation of the two or more signals. In addition, the output of each of attenuators 216 is summed. The sum is then coupled into an input of the op amp as feedback to enable control of attenuators 216 such that the relative signal strength of the two or more signals with respect to each other is maintained.

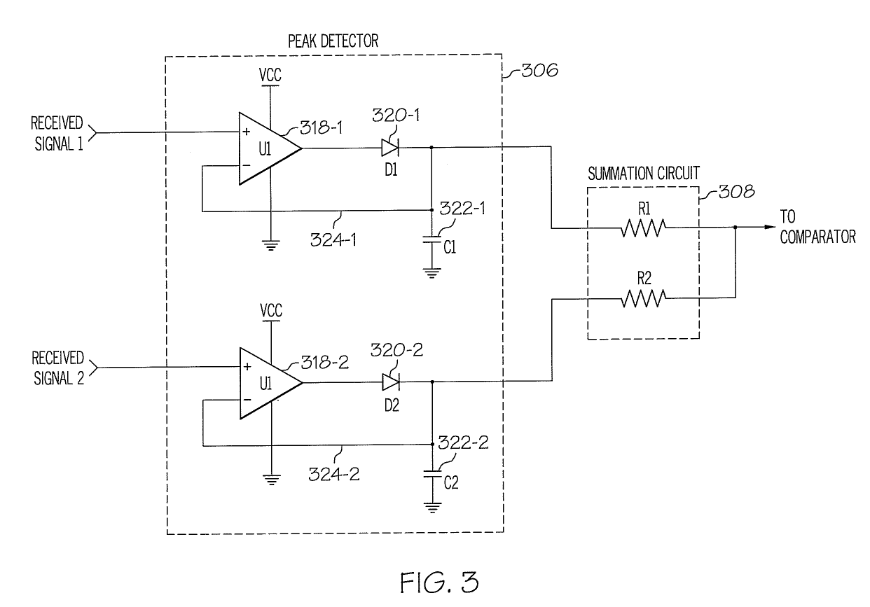

FIG. 3 is a schematic diagram of a peak detector 306 and summation circuit 308 according to one embodiment of the present invention. Peak detector 306 and summation circuit 308 can be used in an AGC circuit such as AGC circuit 202 in FIG. 2. Each of two received signals passes through a peak detector 306. Although two signals are received in this example, it is to be understood that other numbers of signals are received in other embodiments. Peak detector 306 determines the peak voltage on each of the two received signals and converts the respective peak voltages into direct current (DC) voltages.

In particular, peak detector 306 includes operational amplifiers (op amps) 318-1 and 318-2, diodes 320-1 and 320-2, and capacitors 322-1 and 322-2. Op amps 318-1 and 318-2 enable high input impedance which helps prevent the signals from being loaded down and affected by the circuitry in an AGC circuit such as AGC circuit 202 in FIG. 2. Diodes 320-1 and 320-2 direct the detected peak voltages onto capacitors 322-1 and 322-2, respectively. In addition, feedback lines 324-1 and 324-2 provide the voltage level on capacitors 322-1 and 322-2 to op amps 318-1 and 318-2, respectively. The feedback enables op-amps 318-1 and 318-2 to compare and determine the peak voltages for each cycle.

The detected peak voltages are then output to summation circuit 308 as DC voltages from capacitors 322-1 and 322-2. Summation circuit 308 is a simple resistive summation circuit in this example. However, it is to be understood that in other embodiments, other types of summation circuits are used. Summation circuit 308 sums the detected peak voltages. The sum is then output to a comparator such as comparator 210 in FIG. 2.

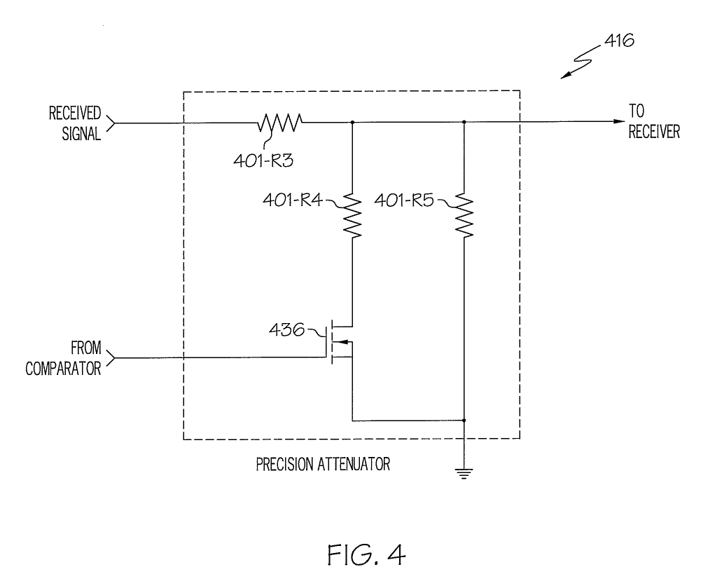

FIG. 4 is a schematic diagram of an attenuator 416 according to one embodiment of the present invention. Attenuator 416 can be used in an attenuator in an AGC circuit such as attenuator 216 in AGC circuit 202 in FIG. 2. Attenuator 416 attenuates a received signal in two discrete attenuation levels. Resistors 401-R3 and 401-R5 form a voltage divider which attenuates the received signal. Attenuator 416 uses switch 436 to switch in resistor 401-R4 in parallel with resistor 401-R5 based on the comparator output.

By switching in resistor 401-R4, the voltage divider changes to attenuate the received signal by a different amount. The attenuation in two or more attenuators 416 can be maintained substantially the same by using the same values for resistors 401-R3, 401-R4, and 401-R5 in each attenuator. In addition, in this example, switch 436 is an N-channel metal-oxide-semiconductor field-effect transistor (MOSFET). However, other switches having a resistance which is low compared to the value of resistor 401-R4 are used in other embodiments.

Although only two levels of attenuation are used in this example, it is to be understood that any appropriate number of discrete attenuation levels are used in other embodiments. For example, in some embodiments, a plurality of resistors parallel to resistor 401-R5 are selectively switched in by a plurality of switches to provide a plurality of discrete attenuation levels. Each of the plurality of switches is controlled by a different comparator output. For example, in one such embodiment an analog-to-digital converter is used in place of a comparator (e.g. comparator 210 in FIG. 2) to provide a digital output. Based on the digital output one or more parallel resistors are switched in parallel to resistor 401-R5. In addition, in other embodiments, attenuator 416 uses a continuous linear function, rather than discrete attenuation levels, to attenuate the received signal based on an output received from a comparator such as comparator 210 in FIG. 2.

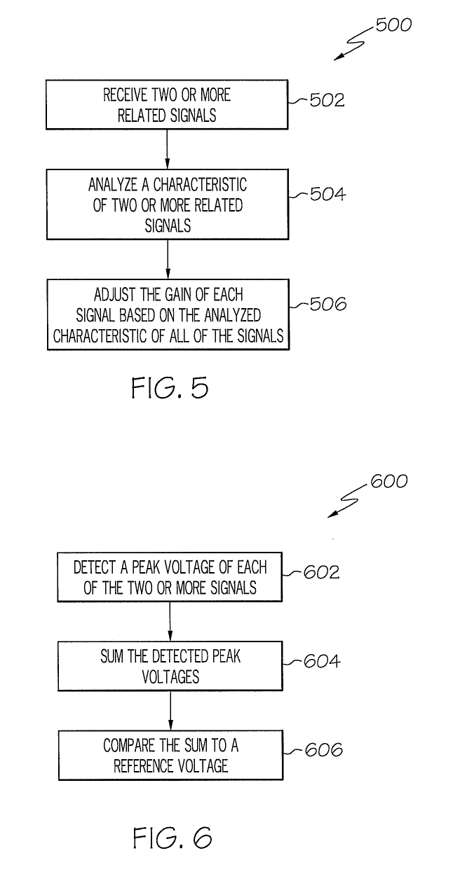

FIG. 5 is a flow chart showing a method 500 of adjusting the gain of two or more related signals according to one embodiment of the present invention. Method 500 can be used in an automatic gain control circuit such as AGC circuit 102 in FIG. 1. At 502, two or more related signals are received. In this example, the two or more signals are related in that the relative signal strength of the two or more signals with respect to each other needs to be maintained. However, in other embodiments, the two or more signals are related in other manners. For example, in an alternative embodiment, the total signal strength of the two or more signals needs to be maintained within a maximum amount but the relative signal strength of the two or more signals does not need to be maintained.

At 504, a characteristic of two or more related signals are analyzed. For example, such analysis can include, but is not limited to, comparing each of the two or more signals to a maximum and/or minimum reference levels. In addition, FIG. 6 depicts an exemplary method of analyzing a characteristic of the two or more related signals.

With reference to FIG. 6, at 602, a peak voltage for each of the two or more related signals is detected by a peak detector such as peak detector 304 in FIG. 3. At 604, a summation circuit, such as summation circuit 308 in FIG. 3, sums the peak voltages detected at 602. At 606, the sum of the peak voltages is compared to a reference value in a comparator, such as comparator 210 in FIG. 2. The output of the comparator determines how the gain of each of the two or more signals is adjusted. For example, if the output of the comparator indicates that the sum of the peak voltages exceeds the reference value, each of the two or more related signals is attenuated.

Returning to FIG. 5, at 506, the result of the analysis of the characteristic of all of the two or more signals is used to adjust the gain for each of the two or more related signals. In this example, based on the analyzed characteristic each of two or more attenuators, such as attenuators 216 in FIG. 2, attenuates one of the two or more received signals. In some embodiments, the two or more attenuators attenuate the related signals by substantially the same amount thereby maintaining the relative signal strength of each signal in relation to the other signal(s). In this way, the gain of each of the two or more related signals is adjusted based on the analysis of all of the two or more related signals. For example, if the analyzed characteristic indicates that the sum of the signal strength of each of the two or more related signals exceeds a threshold, each of the two or more signals is attenuated by substantially the same percentage.

Alternatively, in other embodiments, each of the individual signals is compared to a reference level. If any of the two or more signals exceeds the reference level, all of the two or more signals are attenuated. This is one exemplary alternative for adjusting the gain of each signal based on the analysis of all the signals. However, it is to be understood that in other embodiments, other forms of analysis on all the signals is used to adjust the gain of each of the signals.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An electronic system, comprising:
two or more receivers, each receiver having a defined range for input signals; and
an automatic gain control circuit configured to adjust the gain of two or more signals and pass the two or more adjusted signals to the two or more receivers, wherein the automatic gain control circuit adjusts the gain of each of the two or more signals based on an analysis of all of the two or more signals.

2. The electronic system of claim 1, wherein the automatic gain control circuit adjusts the gain of each of the two or more signals based on a comparison of a sum of the two or more signals with a reference value.

3. The electronic system of claim 1, wherein the automatic gain control circuit adjusts each of the two or more signals substantially equally.

4. The electronic system of claim 1, wherein the automatic gain control circuit adjusts the gain of each of the two or more signals as a continuous linear function.

5. The electronic system of claim 1, wherein the automatic gain control circuit adjusts the gain of the two or more signals in discrete attenuation levels.

6. The electronic system of claim 5, wherein the automatic gain control circuit adjusts the gain of the two or more signals in two discrete attenuation levels.

7. The electronic system of claim 1, wherein the automatic gain control circuit comprises:
a summation circuit configured to sum the two or more signals;
a comparator circuit configured to compare the sum of the two or more signals with a reference value; and
two or more precision attenuators, each attenuator configured to attenuate one of the two or more signals based on the output of the comparator circuit.

8. The electronic system of claim 7, wherein the automatic gain control circuit further comprises a peal detector having two or more operational amplifiers configured to provide high input impedance such that the received signal strength of the two or more signals is substantially unaffected by the automatic gain control circuit.

9. The electronic system of claim 7, wherein the automatic gain control circuit further comprises a hysteresis feedback component configured to provide feedback to the comparator such that small changes in the two or more signals do not cause the output of the comparator to switch back and forth between values.

10. An automatic gain control circuit comprising:
a summation circuit configured to sum a signal strength of two or more signals;
a comparator circuit configured to compare the sum with a reference value; and
two or more precision attenuators, each attenuator configured to attenuate one of the two or more signals based on an output of the comparator circuit.

11. The automatic gain control circuit of claim 10, wherein the attenuator attenuates the two or more signals in discrete attenuation levels.

12. The automatic gain control circuit of claim 10, wherein the attenuator attenuates the two or more signals as a continuous linear function.

13. The automatic gain control circuit of claim 10, further comprising a peak detector having two or more amplifiers configured to provide high input impedance such that the received signal strength of the two or more signals is substantially unaffected by the automatic gain control circuit.

14. The automatic gain control circuit of claim 10, further comprising a hysteresis feedback component configured to provide feedback to the comparator such that small changes in the two or more signals do not cause the output of the comparator to switch back and forth between values.

15. The automatic gain control circuit of claim 10, wherein the two or more attenuators are configured to attenuate substantially equally.

16. A method of adjusting a gain of two or more related signals, the method comprising:
receiving two or more related signals;
analyzing a characteristic of the two or more related signals; and
adjusting the gain of each of the two or more related signals based on the analyzed characteristic of all of the two or more related signals.

17. The method of claim 16, wherein analyzing a characteristic of the two or more signals comprises:
detecting a peak voltage of each of the two or more related signals;
summing the detected peak voltages of the two or more related signals; and
comparing the sum of the detected peak voltages with a reference value, wherein the gain of each of the two or more related signals is based on a result of the comparison.

18. The method of claim 16, wherein adjusting the gain of the two or more related signals comprises adjusting the gain of the two or more related signals substantially equally.

19. The method of claim 16, wherein adjusting the gain of each of the two or more related signals comprises adjusting the gain of the two or more related signals in discrete attenuation levels.

20. The method of claim 19, wherein adjusting the gain of the of the two or more related signals in discrete attenuation levels comprises adjusting the gain of the two or more related signals in two discrete attenuation levels.
